(19) United States
(12) Patent Application Publication
(10) Pub. No.: US 2021/0060824 A1
(43) Pub. Date: Mar. 4, 2021

(54) FIDUCIALS FOR PRECISION OPTICS MOLDING

(71) Applicant: LightPath Technologies, Inc., Orlando, FL (US)

(72) Inventors: Lou Mertus, Orlando, FL (US); Spencer Novak, Winter Springs, FL (US); Alan Symmons, Winter Springs, FL (US)

(21) Appl. No.: 16/557,295

(22) Filed: Aug. 30, 2019

(51) Int. Cl. B29C 33/42; C03B 11/08

(52) U.S. Cl. CPC B29C 33/424; B29L 2011/0016; C03B 11/082

(57) ABSTRACT

Methods and mold designs provide for fiducials in molding glass optical elements, such as glass lenses. A mold for use in the fabrication of a lens can include a first part of the mold including a first molding surface corresponding to a first surface of said lens, and a second part of the mold including a second molding surface corresponding to a second surface of said lens, the first and second part of the mold configured to apply pressure to a moldable material in at least one cavity therebetween, at least one marking structure located on at least one of the first part of the mold, the second part of the mold, or both, the at least one marking structure configured to form at least one fiducial in the molded structure. Such techniques are applicable to precision glass molding.

### FIELD

The present disclosure relates to the fabrication of optics, such as lenses, using molding techniques including, for example, precision glass molding, and in particular the use of fiducials in molding such as precision glass molding.

### SUMMARY

Various implementations of methods and apparatus within the scope of the appended claims each have several aspects, no single one of which is solely responsible for the desirable attributes herein. Without limiting the scope of the appended claims, some prominent features are described herein.

A variety of example systems and methods are provided below.

### Part I

Example 1: A mold for use in the fabrication of a lens, the mold comprising:

a first part of the mold including a first molding surface having at least a portion thereof that is curved such that said first molding surface provides curvature to a corresponding first optical surface of said lens having at least a portion thereof that is curved; and
a second part of the mold including a second molding surface corresponding to a second surface of said lens, the first part of the mold, the second part of the mold, or both configured to move toward each other to apply pressure to a moldable material in at least one cavity therebetween to thereby form a molded structure from the moldable material from which said lens can be obtained,

at least one marking structure located on at least one of the first part of the mold, the second part of the mold, or both, the at least one marking structure configured to form at least one fiducial in the molded structure, wherein the first and second parts of the mold comprise carbide or nickel (e.g., nickel-phosphorous or nickel-boron).

Example 2: [Mold Material] The optical mold of Example 1, wherein the first and second parts of the mold includes tungsten carbide or silicon carbide.

Example 3: [Mold Material] The optical mold of Example 1, wherein the first and second parts of the mold comprise nickel-phosphorous or nickel-boron.

Example 4: [Rotationally Symmetric Surface] The optical mold of any of the examples above, wherein the curved portion of the first molding surface has a shape conforming to an area on a rotationally symmetrical surface.

Example 5: [Spherical Surface] The optical mold of any of Examples 1-3, wherein the curved portion of the first molding surface has a shape conforming to an area on a spherical surface.

Example 6: [Spherical Lens] The optical mold of any of the examples above, wherein said lens comprises a spherical lens.

Example 7: [Aspheric Surface] The optical mold of any of Examples 1-4, wherein the curved portion of the first molding surface has a shape conforming to an area on an aspherical surface.

Example 8: [Conic Surface] The optical mold of any of Examples 1-4 and 7, wherein the curved portion of the first molding surface has a shape conforming to an area on a conic surface.

Example 9: [Aspheric Lens] The optical mold of Examples 1-4 and 7-8, wherein said lens comprises an aspherical lens.

Example 10: [Rotationally Asymmetric Surface] The optical mold of any of Examples 1-3, wherein the curved portion of the first molding surface has a shape conforming to an area on a non-rotationally symmetric surface.

Example 11: [Freeform Surface] The optical mold of any of Examples 1-3 and 10, wherein the curved portion of the first molding surface has a shape conforming to a freeform surface.

Example 12: [Freeform Lens] The optical mold of any of Examples 1-3 and 10-11, wherein said lens comprises a freeform lens.

Example 13: [Glass] The optical mold of any of the examples above, wherein said moldable material, said molded structure, and said lens comprise glass.

Example 14: [Offset Fiducial] The optical mold of any of the examples above, wherein the at least one marking structure is positioned such that the fiducial is outside the optical aperture of the lens.

Example 15: [Offset Fiducial] The optical mold of any of the examples above, wherein the at least one marking structure is offset from the at least a portion of the first surface that is curved.

Example 16: [Offset Fiducial] The optical mold of any of the examples above, wherein the second surface has a portion thereof that is curved so as to provide curvature to at least a portion of said second curved optical surface of said lens.

Example 17: [Multiple Lenses] The optical mold of any of the examples above, wherein the optical mold is configured to produce a plurality of lenses, and wherein the at least one marking structure includes different marking structures for different respective lenses.

Example 18: [Multiple Lenses] The optical mold of any of the examples above, wherein the first mold includes a plurality of sections having respective first surfaces, second surfaces corresponding to the first surfaces, and cavities formed by the respective first and second surfaces to make a plurality of lenses from the molded structure, and wherein the at least one marking structure includes marking structures on respective sections of said mold.

Example 19: [Fiducial Location] The optical mold of Examples 17 or 18, wherein the plurality of marking structures are located on the optical mold such said molded structure includes a plurality of sections including respective fiducials and lenses such that when the plurality of sections of the molded structure are separated, each section includes at least one fiducial and one lens having an optical aperture, the fiducials offset from the from the optical apertures of the lens.

Example 20: [Protruded Marking Structure] The optical mold of the examples above, wherein the at least one marking structure comprises a protruded portion such that the fiducial made therefrom is indented in a surface of the molded structure.

Example 21: [Indented Marking Structure] The optical mold of any of the examples above, wherein the at least one marking structure comprises an indented portion such that the fiducial made therefrom protrudes from a surface in the molded structure.

Example 22: [Two Fiducials Per Lens] The optical mold of any of the claims above, wherein the optical mold is configured to produce a plurality of lenses on the molded structure, and said mold includes at least two marking structures for each lens.

Example 23: [Cross-shaped Marking Structure] The optical mold of any of the examples above, wherein the at least one marking structure can be, for example, cross-shaped, “x” shaped, a circle or another geometric shape, a number, a letter, or a symbol.

Example 24: A method of fabricating a lens having first and second surfaces, at least a portion of said first surface being curved, the method comprising:

providing first and second parts of a mold, said first part of the mold having a first molding surface corresponding to said first surface of said lens, at least a portion of said first molding surface being curved such that the first molding surface provides curvature to said curved portion of said first surface of said lens, said second part of the mold having a second molding surface corresponding to said second surface of said lens;

disposing moldable material between the first and second parts of the mold, said moldable material comprising glass; and

causing the first part of the mold, the second part of the mold, or both to move toward the other to apply pressure to the moldable material in at least one cavity therebetween to thereby form a molded structure from the moldable material from which said lens can be obtained,

wherein at least one marking structure located on at least one of the first part of the mold, the second part of the mold, or both, thereby forms at least one fiducial in the molded structure.

Example 25: [Rotationally Symmetric Surface] The method of Example 24, wherein the curved portion of the first molding surface has a shape conforming to an area on a rotationally symmetrical surface.

Example 26: [Spherical Surface] The method of Examples 24 or 25, wherein the curved portion of the first molding surface has a shape conforming to an area on a spherical surface.

Example 27: [Spherical Lens] The method of any Examples 24-26, wherein said lens comprises a spherical lens.

Example 28: [Aspheric Surface] The method of Examples 24 or 25, wherein the curved portion of the first molding surface has a shape conforming to an area on an aspherical surface.

Example 29: [Conic Surface] The method of any of Examples 24, 25, and 28, wherein the curved portion of the first molding surface has a shape conforming to an area on a conic surface.

Example 30: [Aspheric Lens] The method of any of Examples 24, 25, 28, and 29 wherein said lens comprises an aspherical lens.

Example 31: [Rotationally Asymmetric Surface] The method of Example 24, wherein the curved portion of the first molding surface has a shape conforming to an area on a non-rotationally symmetric surface.

Example 32: [Freeform Surface] The method of Example 24 or 31, wherein the curved portion of the first molding surface has a shape conforming to a freeform surface.

Example 33: [Freeform Lens] The method of any of Examples 24, 31, and 32, wherein said lens comprises a freeform lens.

Example 34: [Second Surface Curved] The method of any of Examples 24-33, wherein the second molding surface of said second part of the mold has a portion thereof that is curved so as to provide curvature to at least a portion of said second surface of said lens.

Example 35: [Heating] The method of any of Examples 24-34, further comprising heating the moldable material, the mold, or both.

Example 36: [Offset Fiducial] The method of any of Examples 24-35, wherein the lens has an optical aperture and the at least one marking structure is positioned such that the at least one fiducial is outside the optical aperture of the lens.

Example 37: [Offset Fiducial] The method of any of Examples 24-36, wherein the at least one fiducial is offset from the at least a portion of the first surface of the lens that is curved.

Example 38: [Removing Fiducial] The method of any of Examples 24-37, further comprising removing said at least one fiducial.

Example 39: [Multiple Lenses] The method of any of Examples 24-38, wherein the optical mold is configured to produce a plurality of lenses, and wherein the at least one marking structure includes different marking structures for different respective lenses.

Example 40: [Multiple Sections] The method of any of Examples 24-39, further comprising forming a plurality of sections in the molded structure, each section configured to provide one lens, and forming at least one fiducial in each of said sections.

Example 41: [Separating Sections] The method of Example 40, further comprising separating the sections of the molded structure.

Example 42: [Fiducial Location] The method of Examples 40 or 41, wherein each section includes at least one fiducial and one lens having an optical aperture, and the fiducials are offset from the from the optical apertures of the lenses.

Example 43: [Two Fiducials Per Lens] The method of any of Examples 24-42, further comprising including at least two fiducials on the molded structure for each lens.

Example 44: [Protruded Marking Structure] The method of any of Examples 24-43, wherein the fiducial is indented in a surface of the molded structure.

Example 45: [Indented Marking Structure] The method of any of Examples 24-44, wherein the fiducial protrudes from a surface in the molded structure.

Example 46: [Cross-shaped Marking Structure] The method of any of Examples 24-45, wherein the fiducial is cross-shaped, “x” shaped, a letter, a number or a symbol.

Example 47: [Cutting Lens from Molded Structure] The method of any of Examples 20-46, further comprising cutting said lens from said molded structure.

Example 48: [Cutting Non-Rotationally Symmetric Lens] The method of any of Examples 20-47, wherein said lens is cut from said molded structure such that said lens is not rotationally symmetric.

### Part II Rotationally Symmetric Curvature

Example 1: A mold for use in the fabrication of a lens, the mold comprising:

a first part of the mold including a first molding surface having at least a portion thereof that is curved such that said first molding surface provides curvature to a corresponding first optical surface of said lens having at least a portion thereof that is curved, the curved portion of the first molding surface having a shape conforming to an area on a rotationally symmetrical surface; and a second part of the mold including a second molding surface corresponding to a second surface of said lens, the first part of the mold, the second part of the mold, or both configured to move toward each other to apply pressure to a moldable material in at least one cavity therebetween to thereby form a molded structure from the moldable material from which said lens can be obtained, at least one marking structure located on at least one of the first part of the mold, the second part of the mold, or both, the at least one marking structure configured to form at least one fiducial in the molded structure, wherein the first and second parts of the mold comprise carbide or nickel (e.g., nickel-phosphorous or nickel-boron).

Example 2: [Mold Material] The optical mold of Example 1, wherein the first and second parts of the mold includes tungsten carbide or silicon carbide.

Example 3: [Mold Material] The optical mold of Example 1, wherein the first and second parts of the mold comprise nickel-phosphorous or nickel-boron.

Example 4: [Spherical Surface] The optical mold of any of the examples above, wherein the curved portion of the first molding surface has a shape conforming to an area on a spherical surface.

Example 5: [Spherical Lens] The optical mold of any of the examples above, wherein said lens comprises a spherical lens.

Example 6: [Aspheric Surface] The optical mold of any of Examples 1-3, wherein the curved portion of the first molding surface has a shape conforming to an area on an aspherical surface.

Example 7: [Conic Surface] The optical mold of any of Examples 1-3 and 6, wherein the curved portion of the first molding surface has a shape conforming to an area on a conic surface.

Example 8: [Aspheric Lens] The optical mold of Examples 1-3 and 6-7, wherein said lens comprises an aspherical lens.

Example 9: [Glass] The optical mold of any of the examples above, wherein said moldable material, said molded structure, and said lens comprise glass.

Example 10: [Offset Fiducial] The optical mold of any of the examples above, wherein the at least one marking structure is positioned such that the fiducial is outside the optical aperture of the lens.

Example 11: [Offset Fiducial] The optical mold of any of the examples above, wherein the at least one marking structure is offset from the at least a portion of the first surface that is curved.

Example 12: [Offset Fiducial] The optical mold of any of the examples above, wherein the second surface has a portion thereof that is curved so as to provide curvature to at least a portion of said second curved optical surface of said lens.

Example 13: [Multiple Lenses] The optical mold of any of the examples above, wherein the optical mold is configured to produce a plurality of lenses, and wherein the at least one marking structure includes different marking structures for different respective lenses.

Example 14: [Multiple Lenses] The optical mold of any of the examples above, wherein the first mold includes a plurality of sections having respective first surfaces, second surfaces corresponding to the first surfaces, and cavities formed by the respective first and second surfaces to make a plurality of lenses from the molded structure, and wherein the at least one marking structure includes marking structures on respective sections of said mold.

Example 15: [Fiducial Location] The optical mold of Examples 13 or 14, wherein the plurality of marking structures are located on the optical mold such said molded structure includes a plurality of sections including respective fiducials and lenses such that when the plurality of sections of the molded structure are separated, each section includes at least one fiducial and one lens having an optical aperture, the fiducials offset from the from the optical apertures of the lens.

Example 16: [Protruded Marking Structure] The optical mold of the examples above, wherein the at least one marking structure comprises a protruded portion such that the fiducial made therefrom is indented in a surface of the molded structure.

Example 17: [Indented Marking Structure] The optical mold of any of the examples above, wherein the at least one marking structure comprises an indented portion such that the fiducial made therefrom protrudes from a surface in the molded structure.

Example 18: [Two Fiducials Per Lens] The optical mold of any of the claims above, wherein the optical mold is configured to produce a plurality of lenses on the molded structure, and said mold includes at least two marking structures for each lens.

Example 19: [Cross-shaped Marking Structure] The optical mold of any of the examples above, wherein the at least one marking structure can be, for example, cross-shaped, “x” shaped, a circle or another geometric shape, a number, a letter, or a symbol.

Example 20: A method of fabricating a lens having first and second surfaces, at least a portion of said first surface being curved, the method comprising:

providing first and second parts of a mold, said first part of the mold having a first molding surface corresponding to said first surface of said lens, at least a portion of said first molding surface being curved such that the first molding surface provides curvature to said curved portion of said first surface of said lens, the curved portion of the first molding surface having a shape conforming to an area on a rotationally symmetrical surface, said second part of the mold having a second molding surface corresponding to said second surface of said lens;

disposing moldable material between the first and second parts of the mold, said moldable material comprising glass; and causing the first part of the mold, the second part of the mold, or both to move toward the other to apply pressure to the moldable material in at least one cavity therebetween to thereby form a molded structure from the moldable material from which said lens can be obtained,

wherein the at least one marking structure being located on at least one of the first part of the mold, the second part of the mold, or both, thereby forms at least one fiducial in the molded structure.

Example 21: [Spherical Surface] The method of Example 20, wherein the curved portion of the first molding surface has a shape conforming to an area on a spherical surface.

Example 22: [Spherical Lens] The method of any Examples 20 or 21, wherein said lens comprises a spherical lens.

Example 23: [Aspheric Surface] The method of Example 20, wherein the curved portion of the first molding surface has a shape conforming to an area on an aspherical surface.

Example 24: [Conic Surface] The method of Example 20 or 23, wherein the curved portion of the first molding surface has a shape conforming to an area on a conic surface.

Example 25: [Aspheric Lens] The method of any of Example 20, 23, and 24 wherein said lens comprises an aspherical lens.

Example 26: [Second Surface Curved] The method of any of Examples 20-25, wherein the second molding surface of said second part of the mold has a portion thereof that is curved so as to provide curvature to at least a portion of said second surface of said lens.

Example 27: [Heating] The method of any of Examples 20-26, further comprising heating the moldable material, the mold, or both.

Example 28: [Offset Fiducial] The method of any of Examples 20-27, wherein the at least one marking structure is positioned such that the at least one fiducial is outside the optical aperture of the lens.

Example 29: [Offset Fiducial] The method of any of Examples 20-28, wherein the at least one fiducial is offset from the at least a portion of the first surface of the lens that is curved.

Example 30: [Removing Fiducial] The method of any of Examples 20-29, further comprising removing said at least one fiducial.

Example 31: [Multiple Lenses] The method of any of Examples 20-30, wherein the optical mold is configured to produce a plurality of lenses, and wherein the at least one marking structure includes different marking structures for different respective lenses.

Example 32: [Multiple Sections] The method of any of Claims Examples 20-31, further comprising forming a plurality of sections in the molded structure, each section configured to provide one lens, and forming at least one fiducial in each of said sections.

Example 33: [Separating Sections] The method of claim 32, further comprising separating the sections of the molded structure.

Example 34: [Fiducial Location] The method of claim 32 or 33, wherein each section includes at least one fiducial and one lens having an optical aperture, and the fiducials are offset from the from the optical apertures of the lenses.

Example 35: [Two Fiducials Per Lens] The method of any of Examples 20-34, further comprising including at least two fiducials on the molded structure for each lens.

Example 36: [Protruded Marking Structure] The method of any of Examples 20-35, wherein the fiducial is indented in a surface of the molded structure.

Example 37: [Indented Marking Structure] The method of any of Examples 20-36, wherein the fiducial protrudes from a surface in the molded structure.

Example 38: [Cross-shaped Marking Structure] The method of any of Examples 20-37, wherein the fiducial is cross-shaped, “x” shaped, a circle or another geometric shape, a number, a letter, or a symbol.

Example 39: [Cutting Lens from Molded Structure] The method of any of Examples 20-38, further comprising cutting said lens from said molded structure.

Example 40: [Cutting Non-Rotationally Symmetric Lens] The method of any of Examples 20-39, wherein said lens is cut from said molded structure such that said lens is not rotationally symmetric.

### Part III Non-Rotationally Symmetric Curvature

Example 1: A mold for use in the fabrication of a lens, the mold comprising:

a first part of the mold including a first molding surface having at least a portion thereof that is curved such that said first molding surface provides curvature to a corresponding first optical surface of said lens having at least a portion thereof that is curved, the curved portion of the first molding surface having a shape conforming to an area on a non-rotationally symmetric surface; and

a second part of the mold including a second molding surface corresponding to a second surface of said lens, the first part of the mold, the second part of the mold, or both configured to move toward each other to apply pressure to a moldable material in at least one cavity therebetween to thereby form a molded structure from the moldable material from which said lens can be obtained,

at least one marking structure located on at least one of the first part of the mold, the second part of the mold, or both, the at least one marking structure configured to form at least one fiducial in the molded structure,

wherein the first and second parts of the mold comprise carbide or nickel (e.g., nickel-phosphorous or nickel-boron).

Example 2: [Mold Material] The optical mold of Example 1, wherein the first and second parts of the mold includes tungsten carbide or silicon carbide.

Example 3: [Mold Material] The optical mold of Example 1, wherein the first and second parts of the mold comprise nickel-phosphorous or nickel-boron.

Example 4: [Freeform Surface] The optical mold of any of Examples 1-3, wherein the curved portion of the first molding surface has a shape conforming to a freeform surface.

Example 5: [Freeform Lens] The optical mold of any of Examples 1-4, wherein said lens comprises a freeform lens.

Example 6: [Glass] The optical mold of any of the examples above, wherein said moldable material, said molded structure, and said lens comprise glass.

Example 7: [Offset Fiducial] The optical mold of any of the examples above, wherein the at least one marking structure is positioned such that the fiducial is outside the optical aperture of the lens.

Example 8: [Offset Fiducial] The optical mold of any of the examples above, wherein the at least one marking structure is offset from the at least a portion of the first surface that is curved.

Example 9: [Offset Fiducial] The optical mold of any of the examples above, wherein the second surface has a portion thereof that is curved so as to provide curvature to at least a portion of said second curved optical surface of said lens.

Example 10: [Multiple Lenses] The optical mold of any of the examples above, wherein the optical mold is configured to produce a plurality of lenses, and wherein the at least one marking structure includes different marking structures for different respective lenses.

Example 11: [Multiple Lenses] The optical mold of any of the examples above, wherein the first mold includes a plurality of sections having respective first surfaces, second surfaces corresponding to the first surfaces, and cavities formed by the respective first and second surfaces to make a plurality of lenses from the molded structure, and wherein the at least one marking structure includes marking structures on respective sections of said mold.

Example 12: [Fiducial Location] The optical mold of Examples 17 or 18, wherein the plurality of marking structures are located on the optical mold such said molded structure includes a plurality of sections including respective fiducials and lenses such that when the plurality of sections of the molded structure are separated, each section includes at least one fiducial and one lens having an optical aperture, the fiducials offset from the from the optical apertures of the lens.

Example 13: [Protruded Marking Structure] The optical mold of the examples above, wherein the at least one marking structure comprises a protruded portion such that the fiducial made therefrom is indented in a surface of the molded structure.

Example 14: [Indented Marking Structure] The optical mold of any of the examples above, wherein the at least one marking structure comprises an indented portion such that the fiducial made therefrom protrudes from a surface in the molded structure.

Example 15: [Two Fiducials Per Lens] The optical mold of any of the claims above, wherein the optical mold is configured to produce a plurality of lenses on the molded structure, and said mold includes at least two marking structures for each lens.

Example 16: [Cross-shaped Marking Structure] The optical mold of any of the examples above, wherein the at least one marking structure can be, for example, cross-shaped, “x” shaped, a circle or another geometric shape, a number, a letter, or a symbol.

Example 17: A method of fabricating a lens having first and second surfaces, at least a portion of said first surface being curved, the method comprising:

providing first and second parts of a mold, said first part of the mold having a first molding surface corresponding to said first surface of said lens, at least a portion of said first molding surface being curved such that the first molding surface provides curvature to said curved portion of said first surface of said lens, the curved portion of the first molding surface having a shape conforming to an area on a non-rotationally symmetric surface, said second part of the mold having a second molding surface corresponding to said second surface of said lens;

disposing moldable material between the first and second parts of the mold, said moldable material comprising glass; and

causing the first part of the mold, the second part of the mold, or both to move toward the other to apply pressure to the moldable material in at least one cavity therebetween to thereby form a molded structure from the moldable material from which said lens can be obtained, wherein the at least one marking structure being located on at least one of the first part of the mold, the second part of the mold, or both, thereby forms at least one fiducial in the molded structure.

Example 18: [Freeform Surface] The method of Example 17, wherein the curved portion of the first molding surface has a shape conforming to a freeform surface.

Example 19: [Freeform Lens] The method of Examples 17 or 18, wherein said lens comprises a freeform lens.

Example 20: [Second Surface Curved] The method of any of Examples 17-19, wherein the second molding surface of said second part of the mold has a portion thereof that is curved so as to provide curvature to at least a portion of said second surface of said lens.

Example 21: [Heating] The method of any of Examples 17-20, further comprising heating the moldable material, the mold, or both.

Example 22: [Offset Fiducial] The method of any of Examples 17-21, wherein the at least one marking structure is positioned such that the at least one fiducial is outside the optical aperture of the lens.

Example 23: [Offset Fiducial] The method of any of Examples 17-22, wherein the at least one fiducial is offset from the at least a portion of the first surface of the lens that is curved.

Example 24: [Removing Fiducial] The method of any of Examples 17-23, further comprising removing said at least one fiducial.

Example 25: [Multiple Lenses] The method of any of Examples 17-24, wherein the optical mold is configured to produce a plurality of lenses, and wherein the at least one marking structure includes different marking structures for different respective lenses.

Example 26: [Multiple Sections] The method of any of Examples 17-25, further comprising forming a plurality of sections in the molded structure, each section configured to provide one lens, and forming at least one fiducial in each of said sections.

Example 27: [Separating Sections] The method of Example 26, further comprising separating the sections of the molded structure.

Example 28: [Fiducial Location] The method of Examples 26 or 27, wherein each section includes at least one fiducial and one lens having an optical aperture, and the fiducials are offset from the from the optical apertures of the lenses.

Example 29: [Two Fiducials Per Lens] The method of any of Examples 17-28, further comprising including at least two fiducials on the molded structure for each lens.

Example 30: [Protruded Marking Structure] The method of any of Examples 17-29, wherein the fiducial is indented in a surface of the molded structure.

Example 31: [Indented Marking Structure] The method of any of Examples 17-30, wherein the fiducial protrudes from a surface in the molded structure.

Example 32: [Cross-shaped Marking Structure] The method of any of Examples 17-31, wherein the fiducial is cross-shaped or “x” shaped.

Example 33: [Cutting Lens from Molded Structure] The method of any of Examples 20-32, further comprising cutting said lens from said molded structure.

### BRIEF DESCRIPTION OF DRAWINGS

The features and advantages of an optical mold apparatus and methods of forming an optical structure having an orientation component formed thereon described herein will become more fully apparent from the following description and appended claims, taken in conjunction with the accompanying drawings. These drawings depict only several embodiments in accordance with the disclosure and are not to be considered limiting of its scope. In the drawings, similar reference numbers or symbols typically identify similar components, unless context dictates otherwise. In some instances, the drawings may not be drawn to scale.

FIG. 1 is a perspective view of an example of a lens molded structure (e.g., a glass structure) having an orientation marker (“fiducial”) on corner of a surface of the lens molded structure. In this example, the fiducial has been cut into the surface (e.g., with a laser) such that it is a “negative” structure. This fiducial can, for example, be indented into the molded structure. In certain implementations, the fiducial can be used to indicate the orientation of the lens molded structure for insertion into an optical system.

FIG. 2 is a perspective view of an example of a lens molded structure (e.g., a glass structure) at a stage after it has been molded and formed into a finalized lens product. In this example, the lens molded structure includes an orientation marker (“fiducial”) directly formed on a surface of the lens molded structure using a marked mold that forms the orientation marker in the molding material (e.g., glass). The orientation marker in this example is a “positive” structure extending outward from the surface of the lens molded structure. This fiducial can, for example, be used to indicate the orientation of the lens molded structure for further processing such as cutting, finishing, or insertion into an optical system.

FIG. 3 illustrates an example of an optical mold apparatus for making a molded structure (e.g. glass) structure having a fiducial formed thereon from which an optical element (e.g., lens) can be obtained. The optical mold apparatus is illustrated in an open (or first) position or configuration having first and second parts separated from each other.

FIG. 4 illustrates an example of an optical mold apparatus such as shown in FIG. 3 in a closed (or second) position.

FIG. 5 illustrates an example of a part of a mold that includes a marking structure for making an molded structure (e.g. glass structure) having a fiducial formed thereon.

FIG. 6 illustrates an example of a part of a mold that includes more than one marking structure (e.g., in this example two marking structures) for making a molded structure (e.g., glass structure) having more than one fiducial formed thereon.

FIG. 7 illustrates an example of a part of a mold that includes more than two (e.g., four) marking structures for making a molded structure (e.g., glass structure) having more than two (e.g. four) fiducials formed thereon. The mold in FIG. 7 illustrates examples of different locations on the mold for the marking structures.

FIG. 8 illustrates an example of a part of a mold of an optical mold apparatus that includes a plurality of marking structures for making a molded structure (e.g., glass structure) having a plurality of fiducials formed thereon. The mold in FIG. 8 illustrates examples of different shaped marking structures.

FIG. 9 illustrates an example of a part of a mold that includes at least one marking structure for making an molded structure (e.g., glass structure) having at least one fiducial formed thereon wherein the molded (e.g., glass) structure may be used to form a freeform lens, which may be an off-axis lens.

FIG. 10 illustrates an example of a part of a mold that can be used to form a molded structure (e.g. glass structure) having a plurality of sections each having at least one marking structure formed thereon.

FIG. 11 illustrates an example of a part of a mold that can be used to form a molded structure (e.g. glass structure) comprising a plurality of sections arrange in an array, each section having at least one marking structure formed thereon.

FIG. 12 illustrates a flowchart of a method of forming a molded structure (e.g. glass structure) that includes at least one marking structure formed thereon.

FIG. 13 illustrates an example of a part of a mold of an optical mold apparatus having a fiducial that can be used to verify that the lens has been molded properly.

### DETAILED DESCRIPTION

The following detailed description is directed to certain specific embodiments of the invention. However, the invention can be embodied in a multitude of different ways. It should be apparent that the aspects herein may be embodied in a wide variety of forms and that any specific structure, function, or both being disclosed herein is merely representative of one or more embodiments of the invention. An aspect disclosed herein may be implemented independently of any other aspects and that two or more of these aspects may be combined in various ways. For example, an apparatus for forming one or more lenses (e.g., an optical mold) may be implemented, or a method may be practiced, using any number of the aspects set forth herein. In addition, such an apparatus may be implemented or such a method may be practiced using other structure, functionality, or structure and functionality in addition to, or other than one or more of the aspects set forth herein.

The development of high quality inexpensive digital imaging technology has led to the widespread use of imaging devices for creating still and video images on cameras and mobile devices (e.g., mobile phones, tablets, etc.). Optical elements, and in particular lenses, are important components in such imaging devices. These imaging devices may include, for example, an optical system comprising one or more lenses disposed in front of an optical detector array. which can reduce the cost of manufacturing. In many cases, these lenses are fabricated by molding. In some cases, these lenses may be made of glass. Other optical instruments and devices also may utilize molded lenses such as molded glass lenses to manipulate light.

Such molded lenses can be produced, for example, using precision glass molding. In some implementations of precision glass molding, glass material such as a glass preform is positioned between two parts of a glass mold having surfaces shaped to match the shape of the desired optical product (e.g., lens). The glass material is heated and the mold parts are brought together thereby compressing and shaping the glass material. High pressure compression as well as high temperature may be employed. In some examples, the glass material can be molded at a pressure of between 5 and 100 PSI. In some examples, the glass material can be molded at a temperature of about 200° C. to about 700° C.

Each part of the mold has a surface shaped to form one of the surfaces of the desired lens product, the surfaces of the glass mold contacting the heated glass material to shape the glass material and form the lens surfaces. In many implementations, the surfaces of the glass mold that contact the glass material may be fabricated to a high degree of precision so as to produce optics having high precision optical surfaces. In some case, for example, the molds are diamond turned to provide such level of precision. Consequently, the surfaces of the lens or other optical element produced by the molds are also high precision. High precision optics can thereby be produced. In some examples, the surfaces can be molded such that the error in the radius of curvature of the curved surface is between 0.1% and 0.025% or 0.01%, for example, within 0.05%, of the radius of curvature. In some examples, the error in the optical power is 3 fringes or less, for example, 3 wavelengths or less, e.g., 1500 nm for a design wavelength of 500 nm, or less, possibly 1.5 wavelengths or less, e.g., 750 nm for a design wavelength of 500 nm, or less. In some implementations, the error in the optical power is 4 or 5 wavelengths or less, e.g., 2000 nm or 2500 nm or less possibly for a design wavelength of 500 nm. In some implementations, the error in the optical power is 2 or 2.5 fringes or less, 2 or 2.5 wavelengths, e.g., 1000 nm or 1250 nm or less for a design wavelength of 500 nm. In some implementations, the error in the optical power is ½ wavelength, for example about 250 nm or possibly less for a design wavelength of 500 nm. Accordingly, in various implementations the error in optical power may be in the range of, for example, 190 to 3700 nm for wavelengths from 380 nm to 740 nm. In some implementations, the error in optical power may be, for example, about 100 nm, 150 nm, 200 nm, 250 nm, 300 nm, 350 nm, 400 nm, 450 nm, 500 nm, 550 nm, 600 nm, 700 nm, 800 nm, 900 nm or any range between any of these values (e.g., from 200 to 400 nm, 250 nm to 350 nm, 250 nm to 450 nm, from 300 to 500 nm or from 300 to 600 nm, etc.), for example, for a 500 nm wavelength. In some cases, the surface irregularity is 1 fringe or less, for example, 1 wavelength or less, e.g., 500 nm or less for a design wavelength of 500 nm. In some cases, the surface irregularity is 2 fringe or less, for example, 2 wavelength or less, e.g., 1000 nm or less for a design wavelength of 500 nm. In some cases, the surface irregularity is ½ wavelength or less, e.g., 250 nm or less for a design wavelength of 500 nm. Accordingly, in various implementations the surface irregularity may be in the range of, for example, 190 to 1480 nm for wavelengths from 380 nm to 740 nm. The surface roughness may be smaller. In various implementations, for example, the surface irregularity may, for example, be about 50 nm rms, 80 nm rms, 100 nm rms, 120 nm rms, 150 nm rms, 180 nm rms, 200 nm rms, 250 nm rms, 300 nm rms, 350 nm rms, 400 nm rms, 450 nm rms, 500 nm rms, 550 nm rms, 600 nm rms, 700 nm rms, 800 nm rms, 900 nm rms or any range between any of these values (e.g., from 50 to 105 nm rms, 50 to 120 nm rms, 80 to 120 nm rms, 80 to 150 nm rms, 50 to 150 nm rms, 80 to 180 nm rms, 50 to 200 nm rms, 80 to 250 nm rms, 200 to 400 nm rms, 250 nm to 350 nm rms, 250 nm to 450 nm rms, 300 to 500 nm rms or from 300 to 600 nm rms, etc.). These values may be root mean square, rms. In some examples, the lens can be molded into a metal housing. For example, a lens can be formed with an optics mount as part of the forming or molding process of the transparent optical element. See, for example, U.S. Patent Publication 2018/0321457, which describes aspects of an optical element molded in an optics mount, and is incorporated herein by reference in its entirety.

In many cases, molding the moldable material (e.g., glass) produces an optical structure that may be referred to herein as a “molded structure” from which the lens or other optical element is obtained/formed/fabricated. The molded structure may comprise substantially optically transmissive or transparent material such as glass and may include the functional surfaces of the optical element such as the powered or curved optical surfaces of the lens. In some implementations, the lenses or optical elements may subsequently be cut from these molded precursor structures using, for example, a wafer saw. In some implementations, the molded structure is the lens.

In some cases, such a molded structure includes a single lens or optical element. In other cases, such a molded structure can include a plurality of lenses or optical elements. For example, the molded structure may include a row of lenses or may include lenses arranged in multiple rows, e.g., across a two-dimensional array or matrix. As stated above, lenses may be cut from these molded structures. For molded structures that include two or more lenses (or two or more other optical components), after the molded structure is formed, the structure can be separated, e.g., cut apart or “diced” to provide a plurality of lens structures. Other optical elements and products (for example, windows, prisms, optical wedges, filters and the like) can also be fabricated from such molded structures in various embodiments.

In various implementations, the lenses comprise spherical or aspherical lenses. For example, these lenses may be formed to have spherical or aspherical optical surfaces that may have optical power. Lenses having an aspheric optical surface may be referred to as aspheric lenses while lenses (e.g., a bi-convex, bi-concave, plano-convex, plano-concave or meniscus lenses) with only spherical surfaces may be referred to as spherical lenses. Some aspheric lens can be designed to reduce or minimize aberration by adjusting a conic constant or aspheric coefficient(s) of the curved surface of the lens. Aspheric lenses may, for example, potentially correct for spherical aberration, an optical effect that causes incident light rays to focus at different points when forming an image, creating a blur. Spherical aberration is commonly seen in spherical lenses, such as plano-convex or double-convex lenses having spherically-shaped optical surfaces. Spherical aberration is inherent in the basic shape of a spherical surface and is independent of alignment or manufacturing errors; in other words, a perfectly designed and manufactured spherical lens may still inherently exhibit spherical aberration. In contrast, aspheric lenses may focus light to a small point, creating comparatively no blur and improving image quality. Aspheric shapes may be used to reduce other aberrations as well.

Moreover, freeform lenses having freeform optical surfaces of arbitrary shape including non-rotationally symmetric shapes can provide a wide range of aberration correction and/or facilitate design flexibility. Accordingly, freeform lenses may be advantageous in many applications.

Off-axis optics such as off-axis lenses having, for example, an optical axis and/or center of rotation that is offset with regard to the mechanical center of the optical element may be employed in many designs. Depending on the particular design, off-axis lenses can include spherical, aspheric, or freeform surfaces. An off-axis lens may include, for example, a parabolic or ellipsoidal lens or another type of aspheric lens having parabolic, ellipsoid or other type of aspheric optical surfaces. These surfaces may conform to the shape of at least a portion of a paraboloid, ellipsoid or aspherical surface, respectively, and have an axis of rotation. In off-axis designs, however, the axis of rotation may not pass through the mechanical center of the lens or might not even pass through the optical surface or even the lens. Other types of lenses may have one or more surfaces that conform to the shape of a rotationally symmetric surface. However, in some implementations, the axis of rotation may not pass through the mechanical center of the lens or might not even pass through the optical surface or even the lens. Similarly, a spherical lens may have an optical axis that does not pass through the mechanical center of the lens or might not pass through the optical surface or even the lens. The optical surfaces of the spherical lens may conform to the surface of a sphere, however, the lens may be cut such that the optical axis that passes through the two centers of curvature of the front and back spherical optical surfaces of the lens may not pass through the mechanical center of the lens or through the optical surface or through the lens. As discussed below, such off-axis lenses may benefit from fiducials to assist in positioning, orienting, and/or aligning the lens.

Anamorphic lenses may also be employed in certain optical designs. Some example anamorphic lenses, such as cylindrical lenses, may have different amounts of optical power and/or different curvatures in different directions. Such configurations may be useful for certain applications.

Any of these different type of lenses or optical elements may potentially have improved performance if they are properly positioned or aligned and/or oriented. In many of these cases, therefore, having a fiducial on the lenses or optical element, may assist in such positioning, alignment, and/or orientation. In many cases, for example, the lenses may not be rotationally symmetrical (e.g., around an axis through the mechanical center), and knowing the orientation of the lenses before they are used in an imaging or other device may be advantageous. Accordingly, it may be beneficial to have a process that facilitates identification of the orientation of the lenses. However, ascertaining the orientation of a molded precursor structure and/or the lenses once the lens has been cut from the precursor structure may be difficult.

To address these and other issues, the optical mold that is used to form such lenses can include at least one marking structure that can be configured to form a fiducial in the molded structure. In various implementations, the marking structure is offset from lens forming surface(s) of the optical mold, e.g., the curved surface(s) of the mold that form the powered optical surface(s) of the lens. Likewise, the fiducial can be offset from a powered or curved lens surface of the molded structure. Advantageously, the fiducial can be used to indicate the orientation and/or position of the molded structure relative, for example, to the optical mold after the molded precursor structure has been removed from the mold and possibly cut up into multiple pieces.

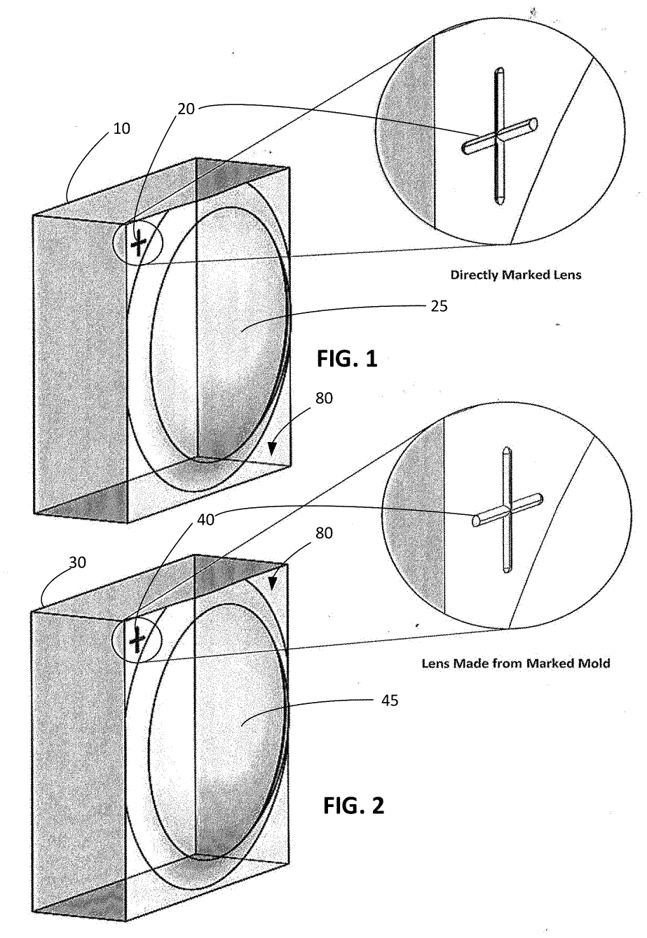

FIG. 1 is a perspective view of an example molded structure 10. The molded structure 10 can be a glass optical structure. In this example, the molded structure 10 is at a stage after it has been molded, and it may be a finalized lens product (e.g., a finished lens). Or, one or more other fabrication steps may be subsequently performed on the molded structure to finalize a lens product. The molded structure 10 includes a first lens surface 25 and an opposing second lens surface (not shown). These surfaces 25 may also be curved optical surfaces or powered optical surfaces in some cases. Such a molded structure 10 can be formed in an optical mold via, for example, precision glass molding. A lens having the first lens surface 25 and the opposing second lens surface (not shown) may be obtained from this molded structure 10 with additional processing.

The molded structure 10 illustrated in FIG. 1 includes an orientation marker (“fiducial”) 20 which has been, in this example, cut (e.g., etched) into a corner of a surface 80 of the molded structure 10. This indented structure may be referred to as a “negative structure.” In some embodiments, the fiducial is formed using a laser to remove a portion of the molded structure (i.e., laser etching). Other methods (e.g., mechanical etching) can also be used. The fiducial can be used to indicate the orientation of the molded structure for further processing, for example, as cutting or insertion into an optical system.

FIG. 2 is a perspective view of another example of a molded structure (e.g., glass optical structure) 30 at a stage after it has been molded. In some embodiments, the molded structure 30 is a finalized lens product. In other examples, the molded structure 30 is a precursor structure and may undergo one or more additional fabrication steps before it is a finalized lens product. For example, the molded structure may be coated to obtain the final product. Accordingly, in some case, the molded structure 30 is a precursor to the final product. In other cases, the molded structure 30 is the final product. The molded structure 30 has a first lens surface 45 and an opposing second lens surface (not shown). In some implementations, one or more these surfaces 45 are curved or powered optical surfaces. Such a molded structure 30 can be formed in an optical mold via, for example, a precision glass mold.

In some cases, the lens may be edged thereafter while in other cases, no subsequent edging, dicing or cutting is involved. In some implementations, after the molded structure 30 is formed, the lens can be cut therefrom. In other implementations, an optical mold can produce a molded structure 30 having a plurality of sections, each containing a lens (or other optical element). In some such implementations, after the molded structure 30 is formed, the different sections can be separated from each other (e.g., by dicing) to obtain a plurality of molded structures that can be formed into optical products (e.g., lenses, filters, etc.). In an example, a precision glass mold may form a molded structure having two sections each having an optical element, and the two sections may be are subsequently separated. In another example, a precision glass mold my form a molded structure having four sections, each having an optical element, and the four sections may be are subsequently separated. In other examples, molded structures can be fabricated having more than four sections. The sections may be separated by dicing or cutting in some implementations.

As illustrated in FIG. 2, the molded structure 30 includes an orientation component (“fiducial”) 40 on a portion of a surface 80 of the molded structure 30 that can be used to indicate the orientation of the molded structure 40. For example, the orientation of the molded structure 30 and the lens surface(s) relative to the optical mold can be readily ascertained with the fiducial. In the example shown in FIG. 2, the orientation component 40 is formed on the molded structure 30 during the lens molding process, extending outward from a surface of the molded structure 30, and is referred to herein as a “positive structure.” In other examples, the orientation component 40 is formed on the molded structure 30 during the lens molding process, and extends inward from a surface of the molded structure 30 and is referred to herein as a “negative structure.” The orientation component 40 is formed during the molding process using the same material that forms the molded structure 30 (e.g., glass). To form the orientation marking, the optical mold used to form the molded structure 30 includes, on one or more surfaces of the mold, a corresponding negative marking structure (to form a positive orientation structure) or a positive marking structure (to form a negative orientation structure). That is, in some implementations, the marking structure on the optical mold may include an indented portion to form a protruding orientation component 40 on the molded structure 30. In other implementations, the marking structure on the optical mold may include a protruding portion to form an indented orientation component 40 on the molded structure 30.

As discussed above, the location of the orientation component 40 can be offset from the portion of the molded structure 30 that will form the optical surface (e.g., powered or curved optical surface) of the lens product. Accordingly, when the finalized lens product has been formed, the orientation component 40 will not interfere with the properties of the powered optical surface of the lens. In some implementations, when the finalized lens product has been formed, the orientation component 40 may have been removed from the finalized lens product. For example, the orientation component 40 may be removed in the process of edging or cutting the lens out of a molded precursor structure. Accordingly, the portion of a molded precursor structure in which the orientation component is formed may be cut away from the portion of the molded precursor structure that includes the powered or curved optical surface(s). In various implementations, material of a molded precursor structure in which the orientation component 40 is formed may be machined away from the material that includes the powered or curved optical surface(s). In other implementations, however the orientation component or fiducial is not removed. The orientation component or fiducial 40 is located on the optical product (e.g., lens) so as not to interfere with optical properties of the optical product.

In various embodiments, the molded structure 30 can include more than one fiducial 40. The fiducial(s) 40 may be of any shape and of any size that is suitable to indicate the orientation of the optical structure 30. In various implementations, when there is more than one fiducial, the fiducials can be the same or similar in size, shape, and structure (e.g., indented or protruding) or may be different in size, shape, and structure (e.g., indented or protruding) in some cases.

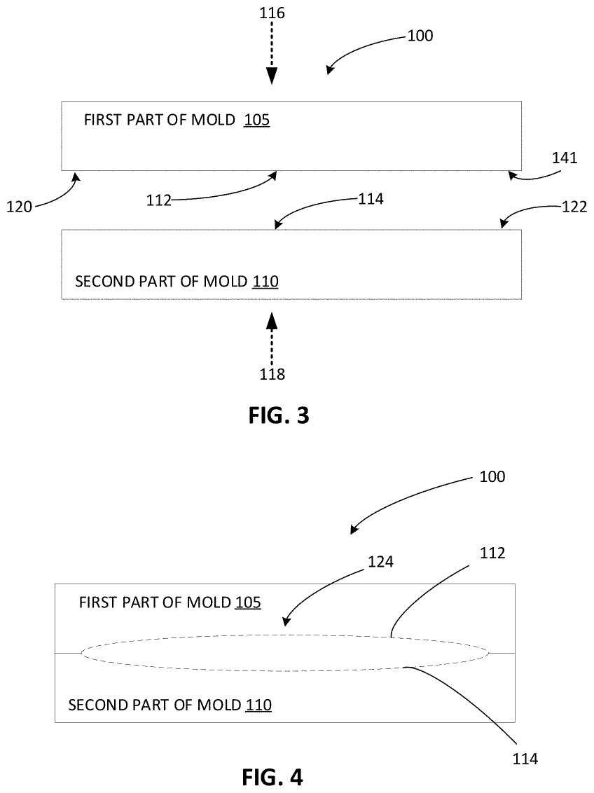

FIG. 3 illustrates an example optical mold apparatus 100 for making the molded structure (e.g., precursor optical structure) having at least one orientation component formed thereon. In FIG. 3, the optical mold apparatus 100 is illustrated in an open (or first) position configuration. In this example, the optical mold apparatus 100 includes a first part of mold 105 and a second part of mold 110. This mold apparatus 100 may be configured to mold glass and, in particular, may be configured for precision glass molding. Accordingly, the mold apparatus and thus the first and second part of molds 105, 110 may be configured to withstand sufficiently high temperatures to mold the glass. In various implementations, therefore, the mold apparatus, e.g., the first and/or second part of molds 105, 110 may comprise tungsten carbide, silicon carbide, nickel-phosphorous, or nickel-boron. In some implementations, the mold apparatus, e.g., the first and/or second part of molds 105, 110 may comprise stainless steel. Other suitable materials may be employed such as other materials capable of operating as a mold under the elevated temperature. Such materials may also have increased hardness compared, for example, to materials that can be used for molding plastic, and the molds may be able to withstand significantly higher temperatures over many cycles than plastic molds.

In operation, to form one or more molded structures 30, the first part of the mold 105 and the second part of mold 110 are brought closer together. For example, the first part of mold 105 can be moved in the direction indicated by arrow 116 with respect to the second part of mold 110, and/or the second part of mold 110 can be moved in the direction indicated by 118 with respect to the first part of mold 105 such that the first part of mold the second part of mold compress the moldable material (e.g., a glass “glob” or “blank”) therebetween. This material and/or the mold may be heated to make the glass more malleable. Infrared lights, for example, can be used to heat the mold and the glass Also, oxygen may be evacuated from the mold, for example, by filling the working area with nitrogen. As illustrated in FIG. 4, the first and second parts of the mold 105, 110 are moved together, pressing the glass in a controlled process such that the heated glass is shaped to match the surfaces of the mold. After the glass is shaped, it is cooled down and the working environment may be filled with nitrogen. When sufficiently cooled, the shaped glass/molded structure can be removed from the mold. Different configurations however are possible and the mold apparatus may operate differently. For example, in some implementations of the optical mold apparatus 100, one or more portions of the first part of mold 105 and the second part of mold 110 may be coupled even when in an open position.

In various implementations, the first part of the mold 105 includes a first surface 112 corresponding to a first surface of one or more lenses that are formed using the first part of the mold 105. The shape of the first surface 112 is used to form the shape of the first surface of one or more lenses. The second part of mold 110 includes a second surface 114 corresponding to a second surface of one or more lenses that are formed using the second part of the mold 110. The shape of the second surface 114 is used to form the shape of the second surface of one or more lenses. In various implementations, either or both the first mold surface 112 and/or the second mold surface 114 can have at least a portion thereof that is a curved for providing curvature, possibly power, to at least a portion of a surface on the lens. Accordingly, first mold surface 112 and/or the second mold surface 114 can have at least a portion thereof having a spherical, aspherical, cylindrical, rotational symmetric, non-rotationally symmetric shapes, freeform shape or any combination thereof for forming spherical, aspherical, cylindrical, rotational symmetric, non-rotationally symmetric shaped or freeform shaped glass surfaces on the lens. Likewise, the first mold surface 112 and/or the second mold surface 114 can have a portion having a shape that conforms to the area of a spherical, aspherical, cylindrical, rotational symmetric, non-rotationally symmetric, or freeform surface.

FIG. 4 illustrates an example of an optical mold apparatus 100 such as shown in FIG. 3 in a closed (or second) position. When the first part of mold 105 and the second part of mold 110 are brought closer together, the moldable material disposed therebetween may be compressed. The first and/or second surfaces 112, 114 of the first and second parts 105, 110 of the mold, respectively, are shaped to form one or more cavities 124 therebetween. The molded structure having the lens surfaces thereon are formed in these one or more cavities in which the molding material is compressed by contact with the first and/or second surfaces 112. Accordingly, in various implementations, these cavities 124 may have a shape corresponding to the shape (e.g., are the negative of the shape) of the molded structures and the optical surfaces of the lens.

The molding material can be glass. A glass preform is be disposed between the first and second parts 105, 110 of the mold to be formed into an optical element by being compressed by the mold parts. Various types of glass may be used for precision glass molding. In various implementations, the glass transition temperature (T_{g}) does not exceed the maximum heating temperature of the mold. The coefficient of thermal expansion (CTE) of the mold and the glass often match, or are about the same. A high CTE difference between the mold and the glass can mean a high deviation between the molded glass and the mold during cooling. In some implementations, the glass may comprise chalcogenide glass. Low T_{g} glass have a glass transition temperature suitable for precision molding and a special glass composition to decrease the tendency for devitrification and to reduce the reaction with mold materials within the molding temperature range. In some implementations, the typical temperature range for the molding process can be between 500° C. and 700° C., enabling the extension of the operating lifetime of the mold material and a significant time reduction of the press process.

FIG. 5 illustrates an example of a part of a mold 105 of an optical mold apparatus that includes a marking structure 120 for forming a fiducial on the molded precursor structure. In this example, the marking structure 120 is in the upper left-hand corner of the mold 105 (in the illustrated orientation). This marking structure 120 may, for example, correspond to the optical fiducial 40 on the molded structure 30 shown in FIG. 1. As illustrated, the marking structure 120 is offset from the portion 112 of the mold 105 that provides curvature to the powered optical surfaces of the lens and thus may be offset from the optical aperture of the lens. The marking structure 120 can have an indented portion and/or a protruded portion, and can have various shapes and be of various sizes.

Accordingly, the first part of mold 105 can include one or more marking structures 120 for forming one or more fiducials. In particular, in some implementations, at least one of the marking structures 120 is located on the first part of mold 105 such that at least one corresponding fiducial is formed on a one side the molded precursor structure by the first part of mold 105. In some implementations, the second part of mold 110 can also include marking structures 122. Likewise, in some implementations, at least one of the marking structures 122 are located on the second part of mold 110 such that at least one corresponding fiducial is formed on the other side of the molded precursor structures by the second part of mold 110. In some implementations, both the first part of mold 105 and the second part of mold 110 include marking structures for forming fiducials on opposite sides of the molded precursor structure. In some implementations, the marking structures 120 of the first part of mold 105 are different in size, shape, and/or location than the marking structures 122 of the second part of mold 110.

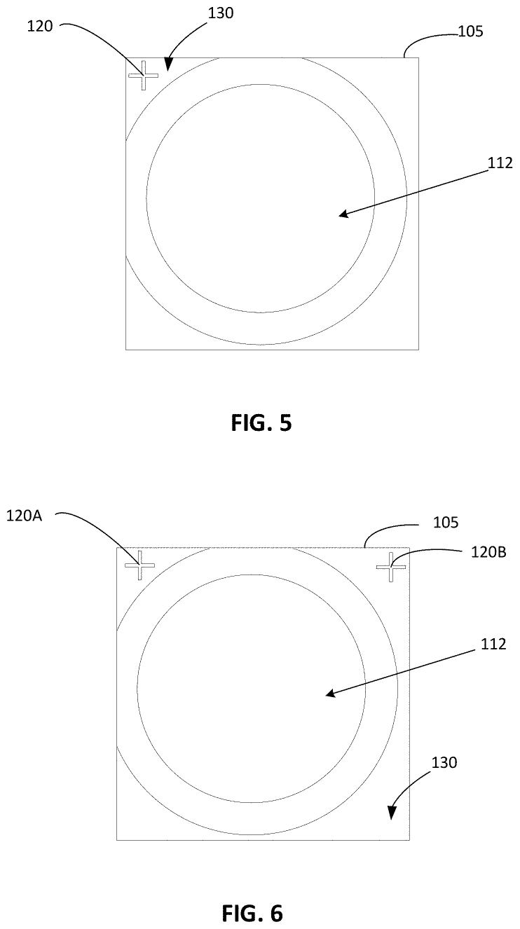

FIG. 6 illustrates an example of a part of a mold 105 of an optical mold apparatus that includes more than one marking structure (e.g., in this example two marking structures) for making a molded precursor structure having more than one fiducial formed on one side of the molded precursor structure. In this example, the mold 105 includes a first marking structure 120A and a second marking structure 120B. Both the first marking structure 120 and the second marking structure 120 are offset from the portion of the surface 112 of the first part of the mold 105 that is used to form a corresponding curved powered optical surface of the resultant lens formed therefrom. Likewise, the fiducials may be off-set from the aperture of the lens.

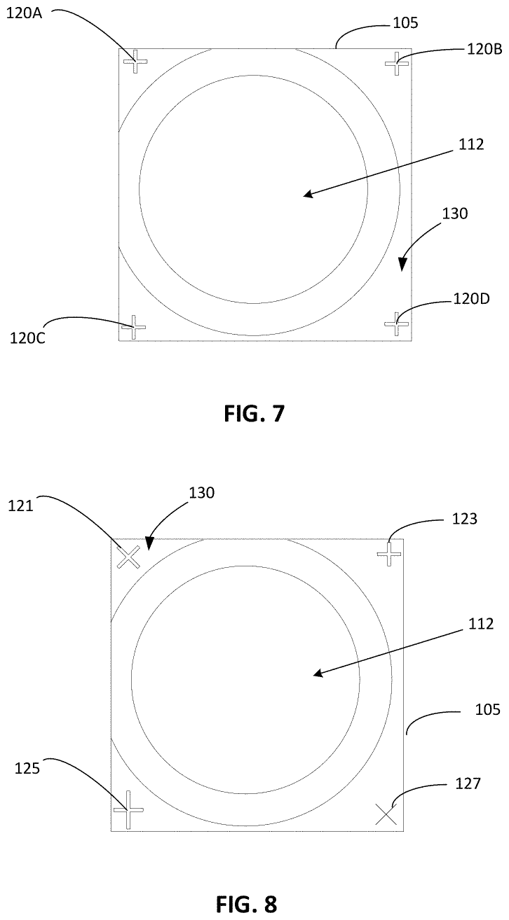

FIG. 7 illustrates another example of a part of a mold 105 of an optical mold apparatus that includes a plurality of marking structures for making an molded precursor structure having a plurality of fiducials formed thereon. The mold in FIG. 7 illustrates examples of different locations of the marking structure on the mold. In this example, the mold 105 includes four marking structures 120A, 120B, 120C, 120D. Each of the marking structures in this example are located on the optical mold 105 at a position that is offset from the portion of the surface 112 that is used to provide curvature and produced a power optical surface of a resultant lens formed therefrom. Accordingly, the fiducials may be offset from the aperture of the lens. Although four (4) marking structures 120A-120D are illustrated in FIG. 7, the number of marking structures may also be different for different designs. Additionally, although the four (4) marking structures 120A-120D are illustrated in FIG. 7 as being the same size and shape, in various designed the size and shape of any of the marking structures 120A-D may be different.

For example, FIG. 8 illustrates an example of a part of a mold 105 of an optical mold apparatus that includes a plurality of marking structures for making a molded structure having a plurality of fiducials formed thereon, wherein the plurality of marking structures on the mold 105 have different sizes (e.g., thicknesses), shapes, and/or orientations. In the example shown in FIG. 8, the mold 105 includes four marking structures 121, 123, 125, and 127. Each of the marking structures is offset from a portion of the surface 112 of the mold 105 that is used to provide curvature and optical power to a corresponding portion of the resultant lens formed from the molded precursor structure. Likewise, the fiducials may be offset from the aperture of the lens. The particular size, shape, orientation, and number of the one or more of the marking structures 121, 123, 125, 127 illustrated in FIG. 8 may be different in various embodiments.

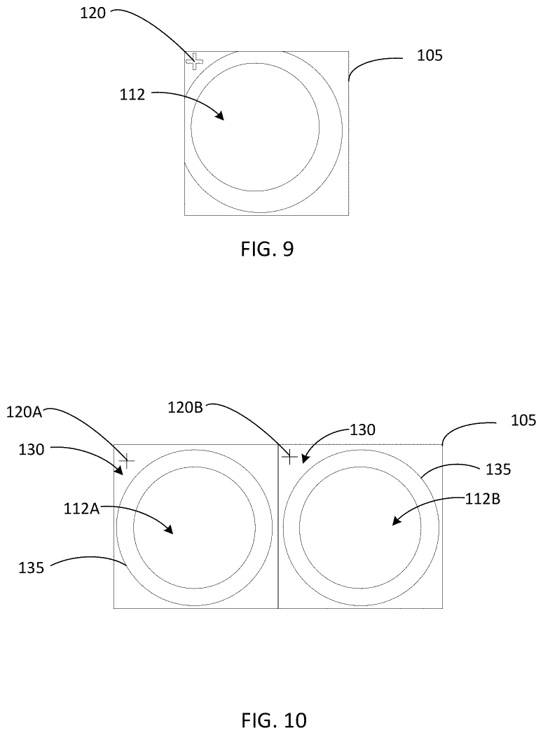

FIG. 9 illustrates an example of a part of a mold 105 of an optical mold apparatus for making a molded structure for forming a freeform lens that may be an off-axis lens. The mold 105 includes at least one marking structure 120 for forming at least one fiducial on the molded structure. In order to form a freeform lens, the mold 105 may be configured with a lens forming surface 112 configured to form a freeform lens surface on the molded structure. As discussed above, freeform lenses have freeform optical surfaces of arbitrary shape including non-rotationally symmetric shapes. Freeform lenses can provide a wide range of aberration correction and/or facilitate design flexibility or otherwise be advantageous in many applications.

Accordingly, lenses formed by the apparatus and processes described herein may have a non-rotationally symmetric shape. The lens may, for example, be an anamorphic lens (e.g., cylindrical lens) having different optical power and curvature in different directions. The lens may also be an off-axis lens having, for example, an optical axis and/or center of rotation that is offset with regard to the mechanical center of the optical element. Depending on the particular design, off-axis lenses can include spherical, aspheric, or freeform surfaces. For example, the lens may have spherical powered surfaces. However, the lens, when cut from the molded precursor structure, may not have an optical axis centered along the mechanical center but may be offset with respect thereto. Likewise, the lens might not have a center of rotation that is aligned with the mechanical center of the lens but may be offset with respect thereto. Similarly, the lens might not have an apex and/or vertex that or is aligned with the mechanical center of the lens but may be offset with respect thereto. One or more fiducials may be particularly useful in orienting the lens in such situations.

As discussed above, in various implementations, the example illustrated in FIG. 9 includes one marking structure 120 located on a part of the mold 105 such that an orientation component or fiducial that is formed on an molded structure, as a result of the marking structure 120, is located on a portion of the molded structure that is removed or cut away when producing the lens from the precursor optical structure. In other implementations, a fiducial remains on the lens and may be used to align the lens in assembling the optical system or constructing the optical device that uses the lens. Fiducials may also be used in cutting, dicing, or edging the molded structure to produce the lens or lenses. For example, can be used as a guide for guiding the saw or cutting tool.

FIG. 10 illustrates an example of a part of a mold 105 of an optical mold apparatus that can be used to form more than one lens. The mold 105 includes a plurality of sections configured to form a molded precursor structure also including a plurality of sections, each configured to yield a lens. In the example shown in FIG. 10, the different sections of the mold 105 each include a marking structure formed thereon configured to produce a fiducial on the respective molded precursor structure. Each section of the optical mold 105 for forming a lens includes at least a portion of a first surface 112 corresponding to a first powered optical surface portion of a lens. The optical mold 105 includes marking orientation structures 120A, 120B located at on a portion of a surface 130 at a position on the optical mold 105 that is outside of a boundary 135 delineating the outside perimeter (or approximately the outside perimeter) of a portion of the optical mold 105 that forms a powered optical surface portion of the resultant lens.

In this implementation, the optical mold 105 has two sections that are configured to produce two corresponding sections in the molded precursor structure that are configured to produce two respective lenses. Although in this implementation, the optical mold 105 is configured to form two lenses, other optical molds 105 may be configured to form more than two lenses. Accordingly, in various implementations, the optical mold 105 includes more than two sections configured to produced more than two corresponding sections in the molded precursor structures, which are configured to produce more than two respective lenses. In some implementations, an optical mold 105 includes a plurality of sections 112A, 112B of a surface for forming a plurality of lens arranged in a row. Each section of the optical mold that forms a corresponding lens can have a corresponding marking structure 120 or a plurality of corresponding marking structures for forming one or more fiducials.

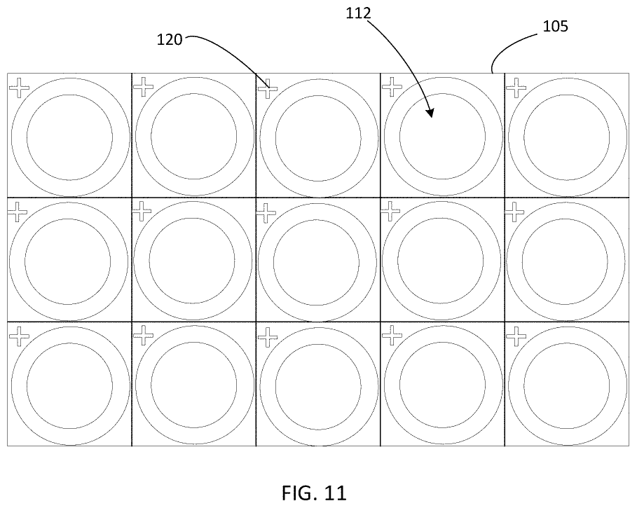

In some implementations, as illustrated in FIG. 11, an optical mold 105 can include a plurality of sections including a plurality portions of surface 112 for forming an array or grid of lens. This example is an array comprising rows and columns (e.g. 3 row and 5 columns). Each section corresponds to one lens. Thus, in this example, fifteen lenses may be produced from the 3 rows and 5 columns. The optical mold 105 also includes a plurality of marking structures 120, one marking structure in each section of the mold in this example design. These marking structures 120 may produce a fiducial in each of the sections of the molded precursor structure. In production, once the molded precursor structure comprising the array of sections is formed using the optical mold 105, the plurality of sections of the molded precursor structure are separated or “diced” into separate pieces. In various implementations, each piece may include at least one orientation component or fiducial formed from a corresponding marking structure 120. In various implementations, the fiducial comprises markings, e.g., lines including possibly dotted lines or other types of lines, to delineate where to cut to dice the molded structure into separate sections. In some such cases, the fiducial may be destroyed in the process of dicing or cutting to separate the different sections. Other fiducials, for example, that assist in orienting the lens may also be included and can remain even if the fiducials used to delineate where to cut or dice are destroyed during dicing.

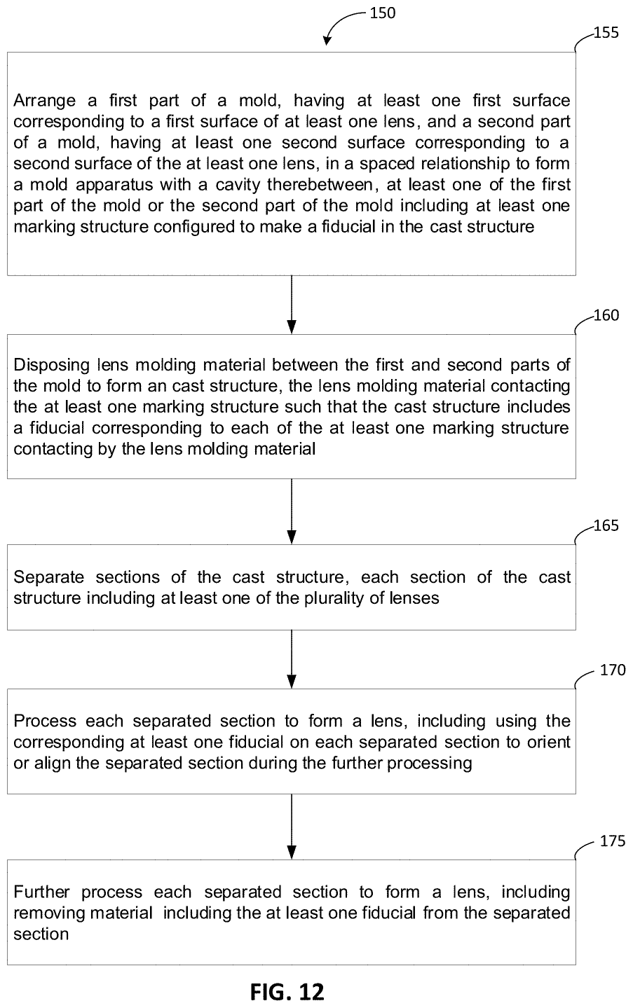

FIG. 12 illustrates a flowchart of a non-limiting example method 150 for forming a plurality of lenses. The method may comprise forming at least one molded structure (e.g. glass precursor structure) such as shown in FIG. 11 that includes a plurality of sections configured to form a plurality of respective lenses. Each of the plurality of sections includes at least one marking structure formed thereon. At block 155, the method includes arranging a first part of the mold, having a first surface for forming a plurality of first surfaces of a plurality of lens, and a second part of the mold, having a second surface for forming a plurality of second surfaces on the plurality of lenses, in a spaced relationship to form a mold apparatus with a cavity therebetween. At least one of the first part of the mold or the second part of the mold includes at least one marking structure configured to make a fiducial in the molded precursor structure. The fiducial can indicate orientation, for example, with respect to the optical mold. In some implementations, the at least one marking structure may be offset from first surface portions of the first surface of the first mold part corresponding to optical surfaces of the resultant lens such that the resulting fiducial is offset from the powered optical surfaces of the resultant plurality of lenses.

At block 160, the method 150 includes disposing lens molding material such as glass between the first and second part of molds to form a molded precursor structure. The lens molding material contacts the at least one marking structure such that the molded precursor structure includes a fiducial corresponding to each of the at least one marking structure contacting by the lens molding material. At block 165, the method 150 includes separating the molded precursor structure into separate portions or pieces, each portion of the molded structure including at least one lenses. At block 170, the method 150 includes processing each separated portion or piece to form a lens, possibly including using the corresponding at least one fiducial on each separated portion to orient or align the separated portion during the further processing. At block 175 the method includes further processing the separated portion to form a lens, possibly including coating the lens and possibly including removing material (e.g., glass) including the at least one fiducial from the separated portion or any combination thereof.

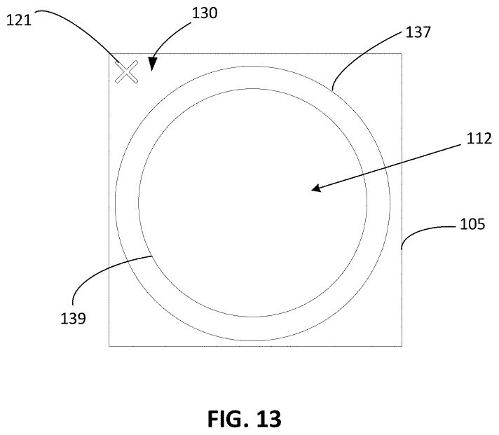

FIG. 13 illustrates an example of a part of a mold 105 of an optical mold apparatus, according to another embodiment. The mold 105 includes at least one marking structure 121 on a portion of the surface 130 of the mold 105 for forming a fiducial on a molded structure. In some embodiments, the at least one marking structure 121 extends outward from a portion of the surface 112 of the mold 105 such that the (positive) at least one marking structure 121 forms a negative fiducial in a molded structure. In some embodiments, the at least one marking structure 121 extends inward from the surface 112 of the mold 105 such that the (negative) at least one marking structure 121 forms a positive fiducial in a molded structure that extends or protrudes outwardly. In FIG. 13, the surface 112 is a portion of the mold 105 that is used to form one of the optical surfaces of a lens of the molded structure, providing curvature and optical power to a corresponding portion of the resultant lens formed from the molded structure. In various embodiments, the mold 105 can also include one or more a marking structures 137 that are located around the curved surface 112 that forms a powered optical surface of the lens. These marking structures 137 may form an outline of the perimeter 139 of the curved surface 112 that forms a powered optical surface of the lens. Accordingly, in various implementations, the marking structures 137 are circular or annular and forms a circular or annular outline around a circular or annular perimeter 139 of the curved surface 112 that forms a powered optical surface of the lens The marking structure 137 an be a “positive” or a “negative” structure that extends outwardly or inwardly. This marking structure 137 may comprise a solid or dotted line or may comprise other types of features to provide an outline around the perimeter 139 of the curved optical surface 112. The marking structure 112 is located at a position on the surface 112 such that for it to generate a corresponding mark on a molded structure, the mold 105 must have fully closed on the glass material being formed into a molded structure such that the first part of the mold 105 meets the second part of the mold 110 (FIG. 2) and the molded structure is properly formed. In other words, when the mold 105 includes a circular marking structure 137, a properly molded structure formed from such a mold will have a corresponding circular fiducial around the lens surface of the molded structure, indicating that the first and second portions of the mold 105, 110 closed together over the glass material sufficiently to form proper lens surfaces on the molded structure. In various examples, the size of the marking structure 112 can be between 0.1 mm to 0.5 or 1 mm (or more) larger than the perimeter 139 of the curved surface 112 used to form the powered lens surface. In one example, if the surface 112 has circular perimeter 139 with a 4 mm diameter, the marking structure 112 may be circular and have a diameter of 5 mm. In various examples, the size of the marking structure 112 can be between 0.1 or 0.5 or 1 mm or 1.5 mm to 2.0, 3.0, 4.0, 5.0 mm (or more) larger than the perimeter 139 of the curved surface 112 used to form the powered lens surface. Other sizes and shapes are possible.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, it will be appreciated that the systems and methods of the disclosure each have several innovative aspects, no single one of which is solely responsible or required for the desirable attributes disclosed herein. The various features and processes described above may be used independently of one another, or may be combined in various ways. All possible combinations and sub-combinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

Additionally, the various processes, blocks, states, steps, or functionalities may be combined, rearranged, added to, deleted from, modified, or otherwise changed from the illustrative examples provided herein. The methods and processes described herein are also not limited to any particular sequence, and the blocks, steps, or states relating thereto may be performed in other sequences that are appropriate, for example, in serial, in parallel, or in some other manner. Tasks or events may be added to or removed from the disclosed example embodiments. Moreover, the separation of various system components in the embodiments described herein is for illustrative purposes and should not be understood as requiring such separation in all embodiments.

It will be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Accordingly, the claims are not intended to be limited to the embodiments shown herein, but are to be accorded the widest scope consistent with this disclosure, the principles and the novel features disclosed herein.

1. A mold for use in the fabrication of a lens, the mold comprising:
a first part of the mold including a first molding surface having at least a portion thereof that is curved such that said first molding surface provides curvature to a corresponding first optical surface of said lens having at least a portion thereof that is curved; and
a second part of the mold including a second molding surface corresponding to a second surface of said lens, the first part of the mold, the second part of the mold, or both configured to move toward each other to apply pressure to a moldable material in at least one cavity therebetween to thereby form a molded structure from the moldable material from which said lens can be obtained,
at least one marking structure located on at least one of the first part of the mold, the second part of the mold, or both, the at least one marking structure configured to form at least one fiducial in the molded structure.

2. (canceled)

3. (canceled)

4. The optical mold of claim 1, wherein the curved portion of the first molding surface has a shape conforming to an area on a rotationally symmetrical surface.

5. The optical mold of claim 1, wherein the curved portion of the first molding surface has a shape conforming to an area on a spherical surface.

6. The optical mold of claim 1, wherein said lens comprises a spherical lens.

7. The optical mold of claim 1, wherein the curved portion of the first molding surface has a shape conforming to an area on an aspherical surface.

8. The optical mold of claim 1, wherein the curved portion of the first molding surface has a shape conforming to an area on a conic surface.

9. The optical mold of claim 1, wherein said lens comprises an aspherical lens.

10. The optical mold of claim 1, wherein the curved portion of the first molding surface has a shape conforming to an area on a non-rotationally symmetric surface.

11. The optical mold of claim 1, wherein the curved portion of the first molding surface has a shape conforming to a freeform surface.

12. The optical mold of claim 1, wherein said lens comprises a freeform lens.

13. (canceled)

14. The optical mold of claim 1, wherein the at least one marking structure is positioned such that the fiducial is outside the optical aperture of the lens.

15. The optical mold of claim 1, wherein the at least one marking structure is offset from the at least a portion of the first surface that is curved.

16. (canceled)

17. The optical mold of claim 1, wherein the optical mold is configured to produce a plurality of lenses, and wherein the at least one marking structure includes different marking structures for different respective lenses.

18. The optical mold of claim 1, wherein the first mold includes a plurality of sections having respective first surfaces, second surfaces corresponding to the first surfaces, and cavities formed by the respective first and second surfaces to make a plurality of lenses from the molded structure, and wherein the at least one marking structure includes marking structures on respective sections of said mold.

19. The optical mold of claim 1, wherein the plurality of marking structures are located on the optical mold such said molded structure includes a plurality of sections including respective fiducials and lenses such that when the plurality of sections of the molded structure are separated, each section includes at least one fiducial and one lens having an optical aperture, the fiducials offset from the from the optical apertures of the lens.

20. The optical mold of claim 1, wherein the at least one marking structure comprises a protruded portion such that the fiducial made therefrom is indented in a surface of the molded structure.

21. The optical mold of claim 1, wherein the at least one marking structure comprises an indented portion such that the fiducial made therefrom protrudes from a surface in the molded structure.

22. The optical mold of claim 1, wherein the optical mold is configured to produce a plurality of lenses on the molded structure, and said mold includes at least two marking structures for each lens.

23. (canceled)

24. A method of fabricating a lens having first and second surfaces, at least a portion of said first surface being curved, the method comprising:
providing first and second parts of a mold, said first part of the mold having a first molding surface corresponding to said first surface of said lens, at least a portion of said first molding surface being curved such that the first molding surface provides curvature to said curved portion of said first surface of said lens, said second part of the mold having a second molding surface corresponding to said second surface of said lens;
disposing moldable material between the first and second parts of the mold, said moldable material comprising glass; and
causing the first part of the mold, the second part of the mold, or both to move toward the other to apply pressure to the moldable material in at least one cavity therebetween to thereby form a molded structure from the moldable material from which said lens can be obtained,
wherein at least one marking structure located on at least one of the first part of the mold, the second part of the mold, or both, thereby forms at least one fiducial in the molded structure.

25.-36. (canceled)

37. The method of claim 24, wherein the at least one fiducial is offset from the first molding surface.

38.-56. (canceled)
